(19) United States
(12) Patent Application Publication
(10) Pub. No.: US 2012/0144433 A1
(43) Pub. Date: Jun. 7, 2012

(54) APPARATUS AND METHOD FOR TRANSMITTING MULTIMEDIA DATA IN WIRELESS NETWORK

(75) Inventors: Seok Ho WON, Daejeon (KR); Sun Hyoung KWON, Seoul (KR); Ho Kyom KIM, Daejeon (KR); Jong Soo LIM, Daejeon (KR); Jin Woo HONG, Daejeon (KR)

(73) Assignee: Electronics and Telecommunications Research Institute, Daejeon (KR)

(21) Appl. No.: 13/310,619

(22) Filed: Dec. 2, 2011

(30) Foreign Application Priority Data
Dec. 7, 2010 (KR) 10-2010-0124549
May 24, 2011 (KR) 10-2011-0049209

(51) Int. Cl. H04N 21/61

(52) U.S. Cl. 725/62

(57) ABSTRACT

Provided are an apparatus and method for transmitting multimedia data in a wireless network. The apparatus and method receive multimedia data classified into at least one layer, and set different radio bearer channels for the respective at least one multimedia layer. Here, a service quality parameter is differentially applied to the respective set radio bearer channels, so that end-to-end quality of service (QoS) improvement is maximized.

### CLAIM FOR PRIORITY

This application claims priority to Korean Patent Applications No. 10-2010-0124549 filed on Dec. 7, 2010 and No. 10-2011-0049209 filed on May 24, 2011 in the Korean Intellectual Property Office (KIPO), the entire contents of which are hereby incorporated by reference.

### BACKGROUND

1. Technical Field

Example embodiments of the present invention relate in general to an apparatus and method for transmitting multimedia data in a wireless network, and more particularly, to a multimedia data transmission apparatus and method in a wireless network utilizing multiple Internet protocol (IP) streams and radio bearers to improve the integrated quality of service (QoS) of a media layer and a network layer.

2. Related Art

As transmission of video data via mobile networks or wireless networks gradually spreads, several techniques are necessary to obtain satisfactory quality at a currently available bit rate in such networks and communication systems.

Meanwhile, several scalable video standards have been suggested for adaptive video streaming technology. As a recent video standard, H.264 provides several types of scalabilities according to available bit rates. Frames or sub-layers of H.264 scalable video coding (SVC) have precedence of dependency due to their hierarchical structure. It is assumed that a packet video is encapsulated using the transmission control protocol (TCP)/IP protocol.

When each sub-stream of SVC or multiview video coding (MVC) in a video layer is served to a terminal in the form of a stream, etc. through a wired network, in particular, an IP network, and a wireless network (e.g., a Third Generation Partnership Project (3GPP) Long Term Evolution (LTE) network) according to related art, too much emphasis is put on QoS optimization of each part (partial optimization), and overall integrated optimization is lacking.

### SUMMARY

Accordingly, example embodiments of the present invention are provided to substantially obviate one or more problems due to limitations and disadvantages of the related art.

Example embodiments of the present invention provide a multimedia data transmission apparatus and method in a wireless network utilizing multiple Internet protocol (IP) streams and radio bearers for resource optimization, in particular, quality of service (QoS) improvement, to improve overall integrated QoS.

In some example embodiments, a method of transmitting multimedia data in a wireless network includes: receiving multimedia data classified into at least one layer; and setting different radio bearer channels for the respective at least one multimedia layer. Here, a service quality parameter is differentially applied to the respective set radio bearer channels.

The service quality parameter may include at least one of a quality of service (QoS) class identifier (QCI) and an allocation retention priority (ARP).

The multimedia data may be classified into a base layer and an enhanced layer, and data related to the base layer may be transmitted using a coding scheme having a lower data rate and a modulation scheme having a lower level than data related to the enhanced layer.

The method may further include allocating at least one radio bearer channel to at least one base station.

The data related to the base layer may be allocated to a base station having larger cell coverage than the data related to the enhanced layer.

The multimedia data classified into the at least one layer may be encoded using at least one of scalable video coding (SVC), three-dimensional (3D) video coding, and multiview video coding (MVC).

Information on precedence of the at least one layer of the multimedia data may be expressed by a traffic class bit in a service type field of an IP version 4 (IPv4) packet or a header of an IP version 6 (IPv6) packet.

The data related to the base layer may be transmitted using a guaranteed bit rate (GBR), and the data related to the enhanced layer may be transmitted using a non-GBR.

In other example embodiments, an apparatus for transmitting multimedia data in a wireless network receives multimedia data classified into at least one layer, and sets different radio bearer channels for the respective at least one multimedia layer. Here, a service quality parameter is differentially applied to the respective set radio bearer channels.

### BRIEF DESCRIPTION OF DRAWINGS

The above and other features and advantages of the present invention will become more apparent by describing in detail example embodiments of the present invention with reference to the accompanying drawings, in which:

FIG. 1 illustrates an example of dependency between frames in H.264 scalable video coding (SVC) to which an example embodiment of the present invention can be applied;

FIG. 2 is a conceptual diagram of range extension of a cell to which an example embodiment of the present invention can be applied;

FIGS. 3A and 3B are graphs showing throughput improvement rates in a downlink and uplink when resource partitioning is used in a mixed cell environment;

FIG. 4 illustrates a macro-relay cell and an example embodiment of a resource partitioning scheme;

FIG. 5 is a table showing the frequency of resource occupation in a macro-relay cell of the range-extension concept according to an example embodiment of the present invention;

FIG. 6 illustrates an example of an automatic retransmission method based on range extension and resource partitioning;

FIG. 7 illustrates an automatic retransmission method based on range extension and resource partitioning according to an example embodiment of the present invention;

FIG. 8 illustrates an automatic retransmission method based on range extension and resource partitioning according to another example embodiment of the present invention;

FIG. 9 illustrates various example embodiments of resource partitioning in a macro-relay cell of the range-extension concept;

FIG. 10 illustrates examples of resource partitioning flexibly applied to a macro-relay cell of the range-extension concept according to a traffic situation; and

FIG. 11 is a flowchart illustrating a method of transmitting multimedia data in a wireless network according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

The term “base station” used herein generally denotes a fixed or moving point communicating with a terminal, and may be referred to as a Node-B, evolved Node-B (eNB), base transceiver system (BTS), access point, and other terms.

Hereinafter, example embodiments of the present invention will be described in detail with reference to the appended drawings. To aid in understanding the present invention, like numbers refer to like elements throughout the description of the figures, and the description of the same component will not be reiterated.

SVC/MVC Layer-Specific QoS, ARP and GBR Mapping

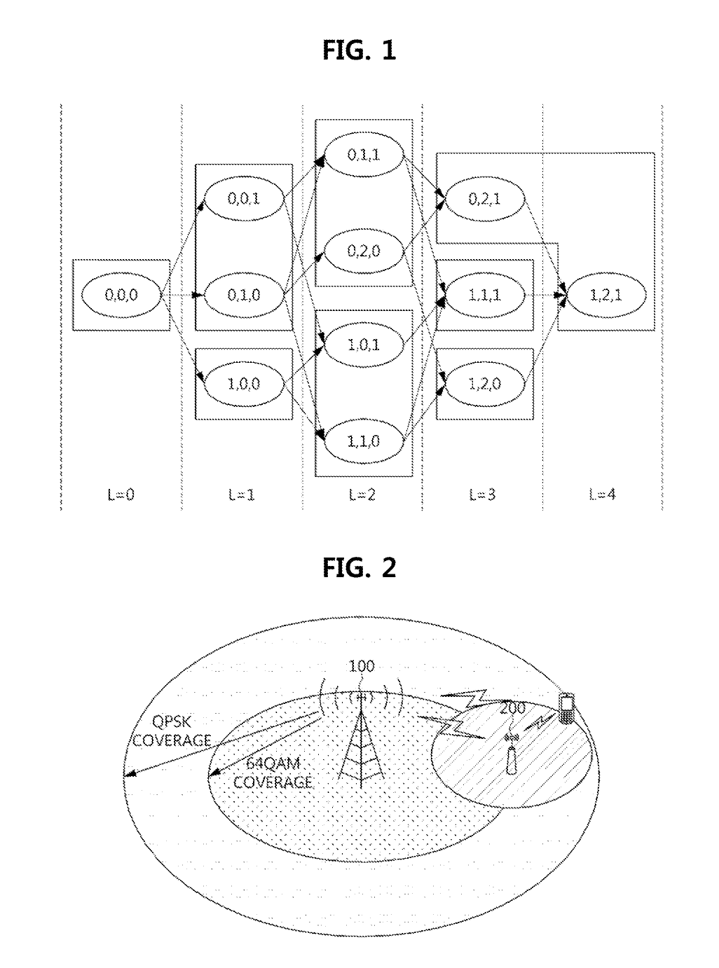

FIG. 1 illustrates an example of dependency between frames in H.264 scalable video coding (SVC) to which an example embodiment of the present invention can be applied.

In the example of FIG. 1, a condition of (d, t, q)max=(1, 2, 1) is applied. Here, d denotes space, t denotes time, and q denotes quality. In a video layer, each sub-stream of SVC or multiview video coding (MVC) may have precedence as in the following example.

It is assumed that, when bitstreams are classified according to layers of SVC video, the bitstreams can be classified according to respective D (spatial), T (temporal) and Q (quality) scalabilities. In FIG. 1, a layer L=0 is referred to as a base layer that is necessary for decoding, and layers L=1, 2, . . . are referred to as enhanced layers. There are layers L=0 to L=4 in the example of FIG. 1.

Respective encoded video layers have dependency during video decoding, and thus arrive at a receiver side according to precedence dependent on the SVC encoding layers, that is, the base layer and the enhanced layers 1, 2, . . . . Thus, as shown in Table 1 below, quality of service (QoS) mapping and allocation retention priority (ARP) allocation may be performed for the respective layers.

TABLE 1

| | NAL | IPv4/IPv6 | | |
|---|---|---|---|---|
| H.264 SVC Sub- | extension | Precedence | 3GPP LTE | |
| layers (d, t, q), L | “priority_id” | (note 1) | QCI (note 2) | ARP (note 3) |
| (0, 0, 0), L = 0 | 0 | 111 (highest) | QCI 5 (PER = 10⁻⁶, 100 ms) | 2 |
| (0, 1, 0), (0, 0, 1), 1 | 1 | 110 | 4 (PER = 10⁻⁶, 300 ms) | 3 |
| (1, 0, 0), 1 | 2 | 101 | 6 (PER = 10⁻⁶, 300 ms) | 4 |
| (0, 1, 1), (0, 2, 0), 2 | 3 | 100 | 8 (PER = 10⁻⁶, 300 ms) | 5 |
| (1, 0, 1), (1, 1, 0), 2 | 4 | 011 | 9 (PER = 10⁻⁶, 300 ms) | 6 |
| (0, 2, 1), (1, 2, 0), 3 | 5 | 010 | 3 (PER = 10⁻³, 50 ms) | 8 |
| (1, 1, 1), 3 | 6 | 001 | 7 (PER = 10⁻³, 100 ms) | 9 |
| (1, 2, 1), (1, 1, 2), 4 | 7 | 000 (lowest) | 2 (PER = 10⁻³, 150 ms) | 10 |
| . . . | . . . | | 1 (PER = 10⁻², 100 ms) | . . . |

Referring to Table 1, an Internet protocol (IP) precedence has three bits (note 1), and an additional bit may be used when further differentiation is needed. Also, according to a packet error/loss rate (PER) and a given delay requirement, the PER is first taken into consideration for a QoS class identifier (QCI) priority, and then a delay attribute is calculated (note 2). Additionally, ARPs numbered 1, 7, 12 and 13 are reserved for a service provider or emergency use (note 3).

When respective layers of SVC media are transmitted, different types of layers may be set for a guaranteed bit rate (GBR) and non-GBR as well as a QoS and ARP. In other words, a base layer may be allocated to one available GBR, and enhanced layers may be allocated to non-GBRs. As a result, the highest priority is given to a video decoding base layer so that the video decoding base layer can be transferred even under poor channel conditions, and lower priorities than that of the base layer are given to enhanced layers.

SVC/MVC layer-Specific Multi-Radio Bearer Allocation and Transmission

When different layers are allocated to the above-mentioned different QoSs, ARPs, GBRs, etc. and transmitted, transmission of a video layer is performed using multi-radio bearers. Here, use of multi-radio bearers means that a network or base station transfers data to one user through two or more channels.

Functions of determining whether or not to allocate resources to respective radio bearers according to priorities dependent on QoS levels of resource blocks (RBs) have already been included in a Long Term Evolution (LTE) standard. Thus, an example embodiment of the present invention providing an SVC video service via an LTE network using such an LTE standard does not require additional cost in terms of functional development. Such a function is prepared for one terminal to execute various applications. For example, to perform voice over Internet protocol (VoIP) communication during web browsing, several RBs having different QoS levels are required.

Also, an operation of setting and supporting different QoSs for respective RBs is performed once when a channel is opened for the first time, and thus does not consume a large amount of resources. The operation is not controlled by a scheduler with reference to CQIs, but is controlled by a radio resource controller (RRC) upon channel setting.

In connection with SVC, several methods may be derived for a scheduler to dynamically control a multimedia stream. Here, in some methods, the amount of resources lost through dynamic control may be larger than that of resources obtained through dynamic control according to situations. Thus, multimedia streams may be appropriately controlled using a semi-persistent scheduling (SPS) function defined for a general streaming service in a media access control (MAC) scheduler.

A method of allocating different QoSs to respective bearers may vary according to networks. For example, different methods as described below are used in an IP network and a Third Generation Partnership Project (3GPP) LTE network.

In an IP network, packet flows are basically managed in units, reservation and admission control are made for GBRs, and a router processes packets on the basis of precedence. On the other hand, an LTE MAC scheduler basically manages packet flows in units of radio bearers (enhanced packet core (EPC) bearers in a higher rank) (like packet flows of the IP). Thus, a link given from the IP to a GBR must be allocated. However, a capacity is checked in advance by admission control, and admission is performed.

In an uplink, resources are allocated according to a transmission request (scheduling request (SR) or buffer status report (BSR)) of a terminal, and whether or not to allocate resources is determined according to precedence dependent on QoS levels of RBs. When resources are actually allocated, the determination is made by analyzing reception performance and a hybrid automatic repeat request (HARQ) ACK/NACK. In a downlink, resources are allocated according to a state of a downlink radio link control (RLC) transmission buffer, and whether or not to allocate resources is determined according to precedence dependent on QoS levels of RBs. When resources are actually allocated, the determination is made by analyzing an HARQ ACK/NACK, CQI, and so on. In the case of IP version 4 (IPv4), D, T and Q identifiers of a network abstraction layer (NAL) unit header may be mapped according to precedence using eight bits of a type of service (TOS) field in an IP header. In the case of IP version 6 (IPv6), eight bits of a traffic class field that can be used for the same purpose as the TOS field of IPv4 may be used.

Efficient Transmission of SVC/MVC Layers

In the best service, all video coding data layers may be transmitted with high QoS and ARP at high GBR. However, it is impossible to provide all users with such a service, and the present invention proposes the following method to provide the best service to as many users as possible.

Specifically, the present invention proposes a method of transmitting a base layer among video coding data layers at a GBR and enhanced layers higher than the base layer at a non-GBR, so that at least the base layer can be transmitted to maintain service even under the poorest transmission conditions.

Here, in an example embodiment of the present invention, a data rate of the base layer is lower than the total of data rates of enhanced layers and thus the base layer is transmitted using low-level modulation (e.g., quadrature phase-shift keying (QPSK)). On the other hand, the enhanced layers are transmitted using high-level modulation (e.g., 64 quadrature amplitude modulation (QAM)).

Another reason that the base layer alone is transmitted at a GBR is that streams for which limited resources are guaranteed need to be minimized Also, a base layer is transmitted at a low data rate for stable transmission, but adaptive modulation and coding (AMC) needs to be used so that transmission is performed at a low coding rate. On the other hand, a high coding rate may be used for enhanced layers, and it is also possible to set a data rate high. As a result, a base layer is transmitted at a low data rate and has a large radius of coverage, and enhanced layers are transmitted at a high data rate and have a small radius of coverage. An example of data transmitted through a base layer at a low data rate includes web browsing data, etc., and an example of data transmitted through enhanced layers at a high data rate includes mobile videophone data, etc.

FIG. 2 is a conceptual diagram of range extension of a cell to which an example embodiment of the present invention can be applied.

Since transmission (Tx) power of an eNB is constant, coverage is reduced to perform transmission at a high data rate. For example, as shown in FIG. 2, the coverage of a case in which a base station 100 performs 64 QAM modulation and then transmission is smaller than that of a case in which QPSK transmission is performed. For range extension, which is intended to compensate for coverage reduction caused by high-level modulation transmission, an apparatus 200, for example, a picocell base station, a relay, or a remote radio head (RRH), as shown in FIG. 2 may be used. As a result, when an eNB aims at a high data rate while maintaining the same coverage, such an apparatus providing additional coverage is needed. In the present invention, regardless of whether or not apparatus such as a picocell base station, a relay, an RRH, and a femtocell have their own unique identifiers, a cell controlled by an apparatus having smaller coverage than a macro base station will be referred to as a microcell for convenience.

In a wireless environment in which a macrocell is adjacent to a microcell or a microcell is adjacent to another microcell, different radio bearer channels may be allocated to the macrocell and microcell or the respective microcells by allocating QoS-related parameters such as QCIs and ARPs having different values according to an example embodiment of the present invention.

In the present invention, data transmission is performed through at least one radio bearer channel, that is, in the form of multiple streams. In this case, separate schedulers operate for the respective radio bearer channels. Thus, a detailed coordination operation utilizing cooperative multi-point (CoMP)/joint processing (JP), etc., which has been discussed with regard to avoiding interference between adjacent cells, etc., is not necessary, and a load on an inter-eNB interface (an X2 interface in the case of 3GPP) placed by data exchanged between base stations can be reduced. The present invention can be applied to relation between macrocells as well as relation between a macrocell and microcell (e.g., a femtocell, a relay cell, and a picocell).

Here, in an example embodiment of the present invention, a PER and delay constraint may be determined using a QCI. In another example embodiment of the present invention, a base layer may be distinguished from enhanced layers using an ARP rather than a QCI. For example, a layer whose ARP is 2 may be classified as a base layer, and layers whose ARPs are not 2 may be classified as enhanced layers. A base layer modulated at a low modulation level (e.g., QPSK) can be transmitted through a microcell, but this may be a waste of resources because the coverage is sufficient and resources need to be allocated for a GBR in a microcell.

Combination of Range Extension and Resource Partitioning

It has been known that when resources are partitioned and used by a picocell for range extension and a macrocell, throughput is approximately doubled. In other words, a high data rate involves short coverage and thus requires range extension. When a range is extended using a relay, a donor cell (or macrocell) interferes with a relay cell. In this case, interference between the macrocell and the relay cell may be avoided using resource partitioning.

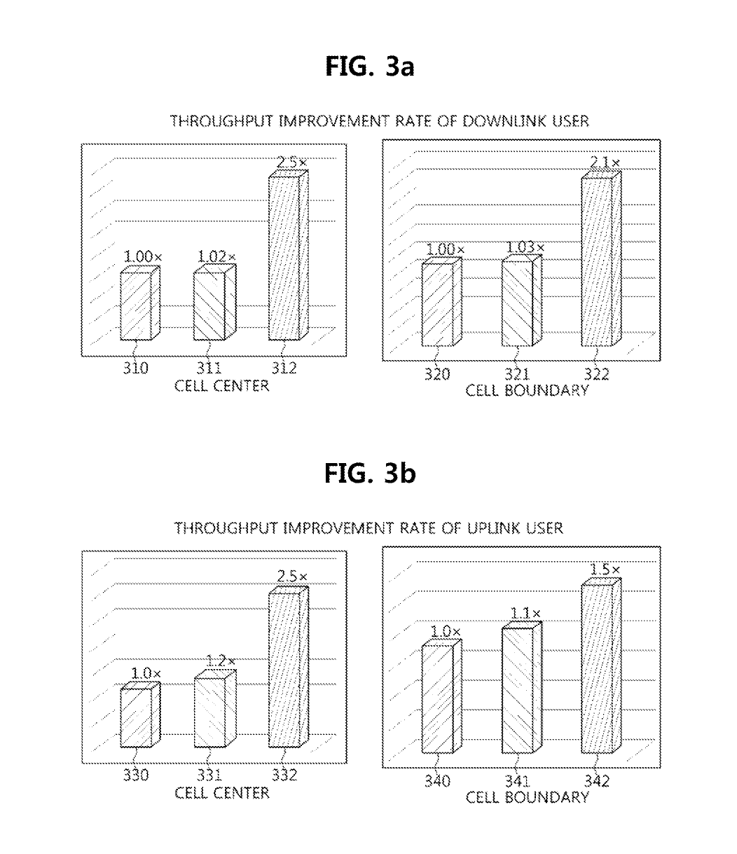

FIGS. 3A and 3B are graphs showing throughput improvement rates in a downlink and uplink when resource partitioning is used in a mixed cell environment.

FIG. 3A illustrates the case of a downlink. A graph shown on the left side of FIG. 3A shows throughput improvement rates when a macrocell is managed alone in a cell center area (310), when a macrocell and microcell are managed together in a cell center area (311), and when each of a macrocell and a microcell is scheduled through resource partitioning while managed together in a cell center area (312). Also, a graph shown on the right side of FIG. 3A shows throughput improvement rates when a macrocell is managed alone in a cell boundary area (320), when a macrocell and microcell are managed together in a cell boundary area (321), and when each of a macrocell and a microcell is scheduled through resource partitioning while managed together in a cell boundary area (322).

Meanwhile, FIG. 3B illustrates the case of an uplink. A graph shown on the left side of FIG. 3B shows throughput improvement rates when a macrocell is managed alone in a cell center area (330), when a macrocell and microcell are managed together in a cell center area (331), and when each of a macrocell and a microcell is scheduled through resource partitioning while managed together in a cell center area (332). A graph shown on the right side of FIG. 3B shows throughput improvement rates when a macrocell is managed alone in a cell boundary area (340), when a macrocell and microcell are managed together in a cell boundary area (341), and when each of a macrocell and a microcell is scheduled through resource partitioning while managed together in a cell boundary area (342).

In FIG. 3A illustrating the case of a downlink and FIG. 3B illustrating the case of an uplink, it is possible to check the maximum throughput improvement rate of 2.5. In an example embodiment of FIG. 3, the microcell may be controlled by a relay.

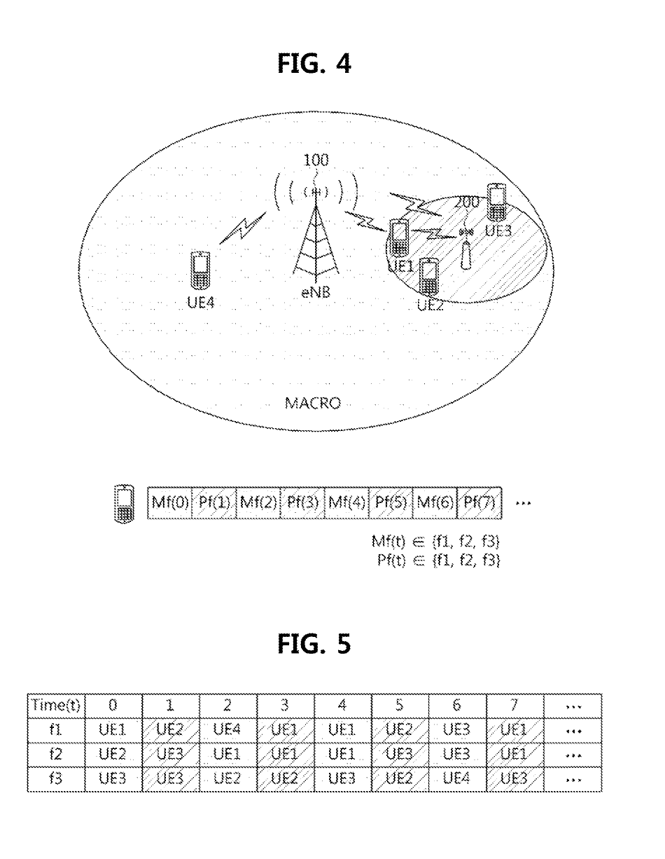

FIG. 4 illustrates a macro-relay cell and an example embodiment of a resource partitioning scheme.

In FIG. 4, Mf(t) denotes resource allocation in a macrocell, and t is a time index. Pf(t) denotes resource allocation in a relay cell. In an example embodiment illustrated in FIG. 4, frequency resources are present in the form of {f1, f2, f3}.

In the example embodiment of FIG. 4, frequency resources are not limited, and a base station 100 and a relay 200 appropriately select and use the given frequency resources. Here, resource allocation between the base station 100 and the relay 200 is sectioned according to time.

Although one macrocell and one relay cell coexist in the example embodiment of FIG. 4, a plurality of macrocells and a plurality of relay cells may coexist in another example embodiment of the present invention. Also, the microcell is illustrated in the form of a relay in FIG. 4, but can be in the form of a femtocell, picocell, and so on.

In connection with the example embodiment of FIG. 4, FIG. 5 shows the frequency of resource occupation in a macro-relay cell of the range-extension concept according to an example embodiment of the present invention.

FIG. 5 shows resource allocation when a time t elapses as 0, 1, 2, . . . . In FIG. 5, a relay and base station perform transmission to a terminal in only a time section allocated to each of them, like in the example embodiment of FIG. 4. More specifically, in FIG. 5, times 0, 2, 4 and 6 are time sections allocated to the base station, and times 1, 3, 5 and 7 are time sections allocated to the relay.

Each of the base station and relay appropriately allocates frequency resources f1, f2 and f3 to a terminal served by each of them in a time section allocated thereto, which can be confirmed in FIG. 5. UE4 is served by the base station only, and UE1, UE2 and UE3 are served by the base station and relay.

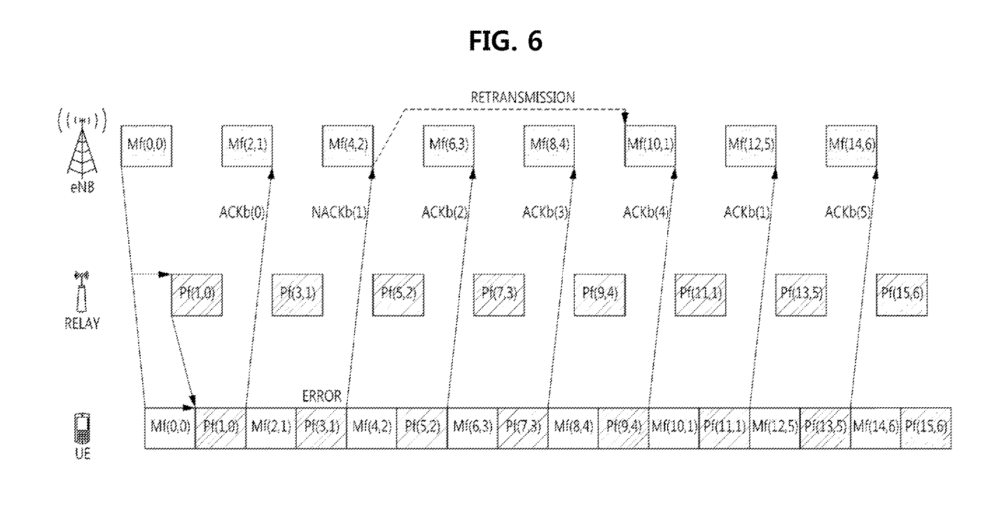

FIG. 6 illustrates an example of an automatic retransmission method based on range extension and resource partitioning.

In other words, FIG. 6 illustrates an example of an HARQ scheme under a resource partitioning condition in a macro-relay cell of a range-extension concept.

In a resource Mf(t, i), t is a time index, and i is an index of a packet order. The operation example of FIG. 6 will be described in detail below.

Step 1: A packet (i=0) is transmitted from a macrocell through a resource Mf(0, 0) at t=0.

Step 2: After a transmission delay time elapses, the packet arrives at a relay and a terminal. The relay forwards the packet that is received from an eNB at t=0 to a UE at t=1. In FIG. 6, the packet is indicated as Pf(1, 0).

Step 3: The UE combines the packet received from the eNB through the resource Mf(0, 0) at t=0 with the packet Pf(1, 0) received from the relay at t=1 so as to finally determine whether or not there is an error in the packet, and transmits ACK(0) for a packet id of 0 to the eNB.

Step 4: For example, when there is an error in the packet (i=0) received and decoded by the UE, NACK(1) for the packet (i=0) is transmitted to the eNB.

Step 5: After transmitting some packets according to the number of HARQ processes, the eNB retransmits the packet in which an error has occurred. In this example embodiment, a packet (i=1) is retransmitted through a resource Mf(10, 1) at t=10.

The HARQ scheme for resource partitioning in a macro-relay cell of the range-extension concept illustrated in FIG. 6 has a simple procedure and enables stable packet transmission and reception. On the other hand, in the case of low-speed data transmission, reliability is unnecessarily increased for a packet having a low modulation level and low channel rate, resulting in a waste of resources.

Therefore, the present invention utilizes an automatic retransmission method based on resource partitioning in a macro-relay cell of the range-extension concept.

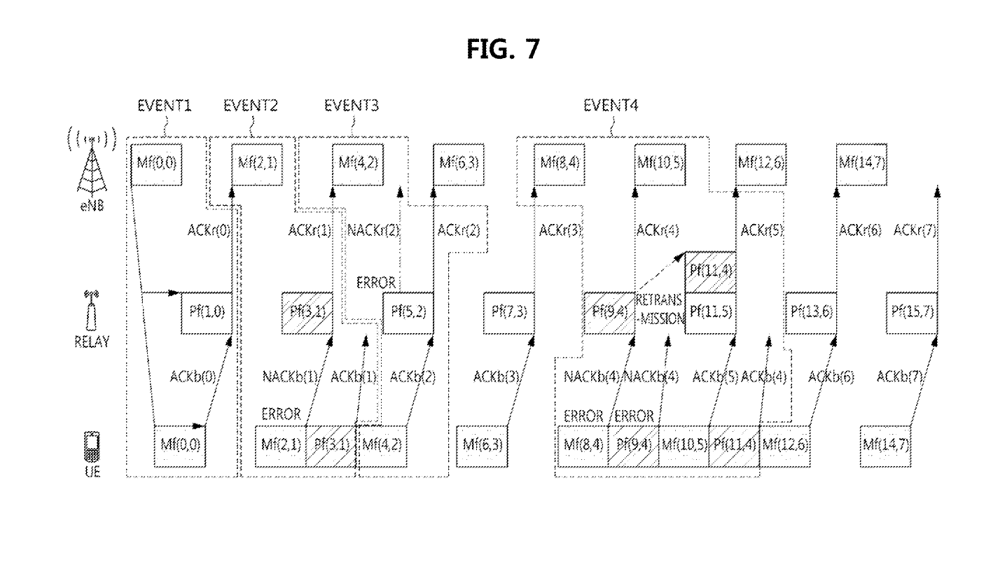

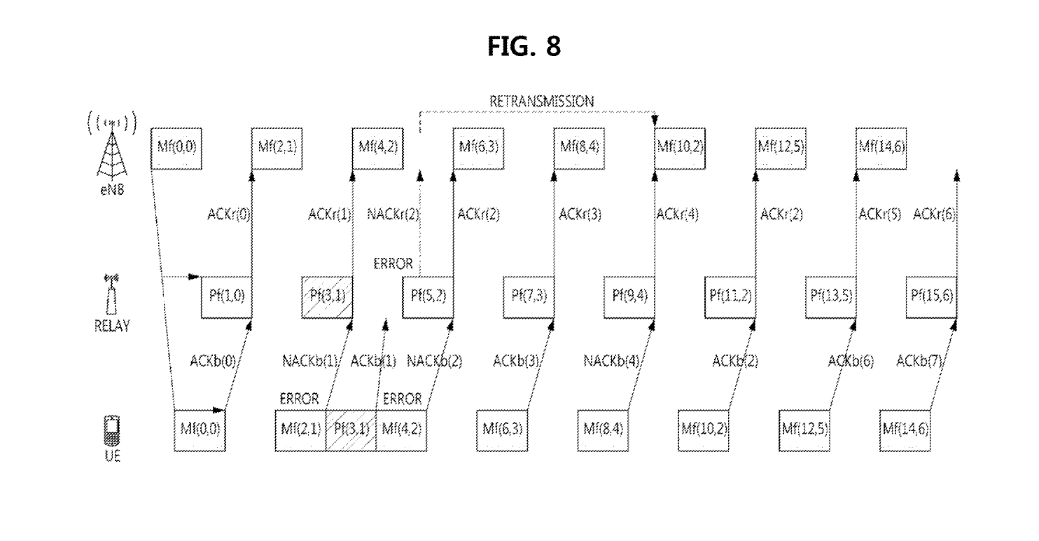

An automatic retransmission method based on range extension and resource partitioning according to example embodiments of the present invention will be described below with reference to FIGS. 7 and 8.

FIG. 7 illustrates an automatic retransmission method under a resource partitioning condition in a macro-relay cell of the range-extension concept according to an example embodiment of the present invention. In other words, FIG. 7 illustrates a method for solving the problem of the HARQ scheme for resource partitioning in a macro-relay cell of the range-extension concept illustrated in FIG. 6.

In this example embodiment, when there is no error in a packet transferred from an eNB to a UE, the next packet is transmitted, and when there is an error in a packet transferred from the eNB to the UE, a packet received by a relay is transmitted to the UE.

An operation example of event 1 among operation examples of the present invention is as follows.

Step 1: An eNB transmits a first packet (i=0) through a macrocell resource Mf(0, 0) at t=0.

Step 2: The first packet arrives at a relay and UE after a transmission delay time.

Step 3: The relay decodes the first packet, and buffers the packet when there is no error in the packet.

Step 4: The UE decodes the first packet received through Mf(0, 0), and determines whether or not there is an error in the packet. When there is no error, the UE transmits ACKb(0) to the relay.

Step 5: When ACKb(0) is received from the UE, the relay transmits ACKr(0) for the packet (i=0) to the eNB.

Next, an operation example of event 2 is as follows.

Step 1: The eNB transmits a second packet (i=1) through a macrocell resource Mf(2, 1) at t=2.

Step 2: The relay receives and decodes the second packet, and buffers the packet when there is no error in the packet.

Step 3: When it is determined that there is an error in the second packet received through the resource Mf(2, 1) at t=2, the UE transmits NACKb(1) to the relay.

Step 4: When NACKb(1) is received from the UE, the relay transmits an ACKr(1) for the packet (i=1) to the eNB and a packet Pf(3, 1) buffered therein to the UE.

Step 5: The UE receives the packet Pf(3, 1), and transmits ACKb(1) when there is no error in the packet.

Step 6: The relay receiving ACKb(1) from the UE does not perform retransmission because the relay recognizes that the packet (i=1) has been transferred to the UE with no error.

Next, an operation example of event 3 is as follows.

Step 1: The eNB transmits a third packet (i=2) through a macrocell resource Mf(4, 2) at t=4.

Step 2: The third packet arrives at the relay and UE after a transmission delay time.

Step 3: The relay receives and decodes the third packet, and discards the packet when there is an error in the packet.

Step 4: The UE receives and decodes the packet received through Mf(4, 2), and determines whether or not there is an error in the packet. When there is no error, the UE transmits ACKb(2) to the relay.

Step 5: When ACKb(2) is received from the UE, the relay transmits ACKr(2) for the packet (i=2) to the eNB.

Finally, an operation example of event 4 is as follows.

Step 1: The eNB transmits a fifth packet (i=4) through a macrocell resource Mf(8, 4) at t=8.

Step 2: The fifth packet arrives at the relay and UE after a transmission delay time.

Step 3: The relay receives and decodes the fifth packet, and buffers the packet when there is no error in the packet.

Step 4: When it is determined that there is an error in the fifth packet received through the resource Mf(8, 4) at t=8, the UE transmits NACKb(4) to the relay.

Step 5: When NACKb(4) is received from the UE, the relay puts the packet buffered in step 3 in Pf(9, 4) and transmits the packet to the UE at t=9, and transmits an ACKr(4) for the packet (i=4) to the eNB.

Step 6: The UE decodes the packet put in Pf(9, 4) and received from the relay, and determines whether or not there is an error in the packet. When there is an error in the packet, the UE retransmits ACKb(4) to the relay.

Step 7: The relay receiving ACKb(4) performs resource scheduling for the packet (i=4), and retransmits the packet to the UE at a proper time. In the example embodiment of the present invention illustrated in FIG. 7, retransmission is performed at t=11. In other words, the eNB directly transfers a packet (i=5) to the UE with no error, and at this time, the relay recognizes that there are available resources between the relay and the UE and retransmits Pf(11, 4) to the UE at t=11.

Step 8: The UE receives Pf(11, 4) transmitted in step 7 from the relay, decodes Pf(11, 4), and transmits ACKb(4) to the relay to prevent the relay from performing retransmission when there is no err in Pf(11, 4).

FIG. 8 continuously illustrates the automatic retransmission method of FIG. 7 under the resource partitioning condition in the macro-relay cell of the range-extension concept, particularly illustrating event 5 in detail.

An operation example of event 5 illustrated in FIG. 8 is as follows.

Step 1: The eNB transmits a third packet (i=2) through a macrocell resource Mf(4, 2) at t=4.

Step 2: The third packet arrives at the relay and UE after a transmission delay time.

Step 3: The relay receives and decodes the third packet, and discards the packet when there is an error in the packet.

Step 4: The UE receives and decodes the packet received through Mf(4, 2), and determines whether or not there is an error in the packet. When there is an error, the UE transmits NACKb(2) to the relay.

Step 5: The relay receives NACKb(2) from the UE, and transmits NACKr(2) to the eNB when there is also an error in the packet received from the eNB, like in step 3.

Step 6: The eNB receiving NACKr(2) from the relay performs retransmission in consideration of eNB resource scheduling for the packet (i=2) or HARQ process management rules. In this example embodiment, the packet (i=2) is retransmitted through a resource Mf(10, 2) at t=10.

Step 7: The packet retransmitted in step 6 is processed in the same way as the above-described procedure.

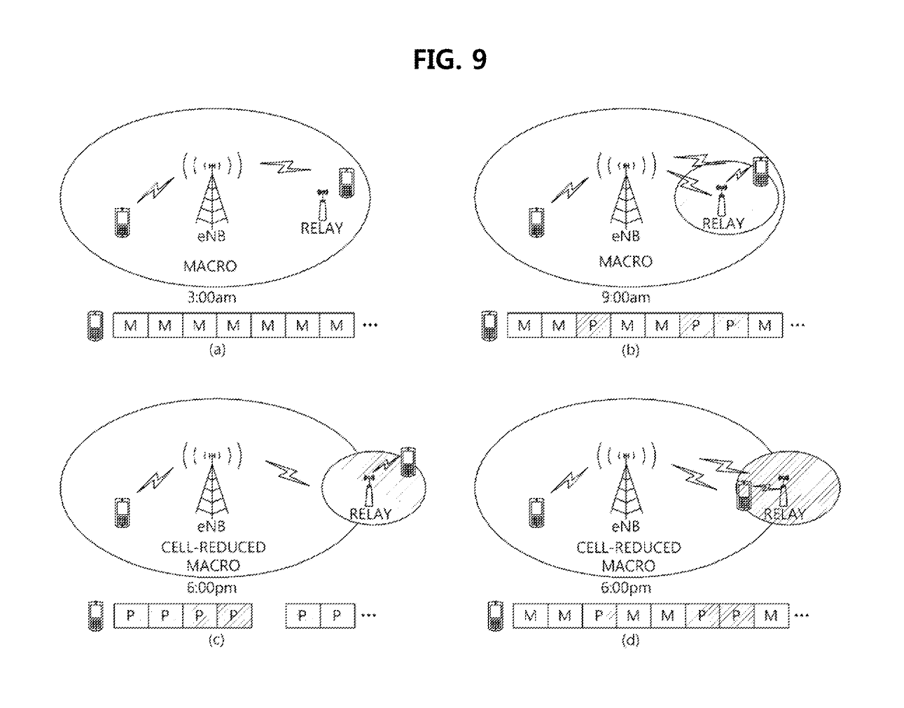

FIG. 9 illustrates various example embodiments of resource partitioning in a macro-relay cell of the range-extension concept.

(a), (b), (c) and (d) of FIG. 9 illustrate resource distribution according to dispersion of UEs dependent on time and situation, a change in cell radius (generally referred to as cell breathing) according to a service transmission rate and the amount of traffic dependent on time and situation, and a resource partitioning scheme in the corresponding macro-micro cell of the range-extension concept. FIG. 9 shows a relay cell as an example of a microcell.

(a) illustrates resource distribution according to a cell situation at 3 AM, and (b) illustrates resource distribution according to a cell situation at 9 AM. (c) and (d) illustrate resource distribution in cell environments at 6 PM. (c) illustrates a case in which all resources are allocated to a terminal accessing a relay, and (d) illustrates a case in which resources are dispersively distributed to a macrocell and a relay cell.

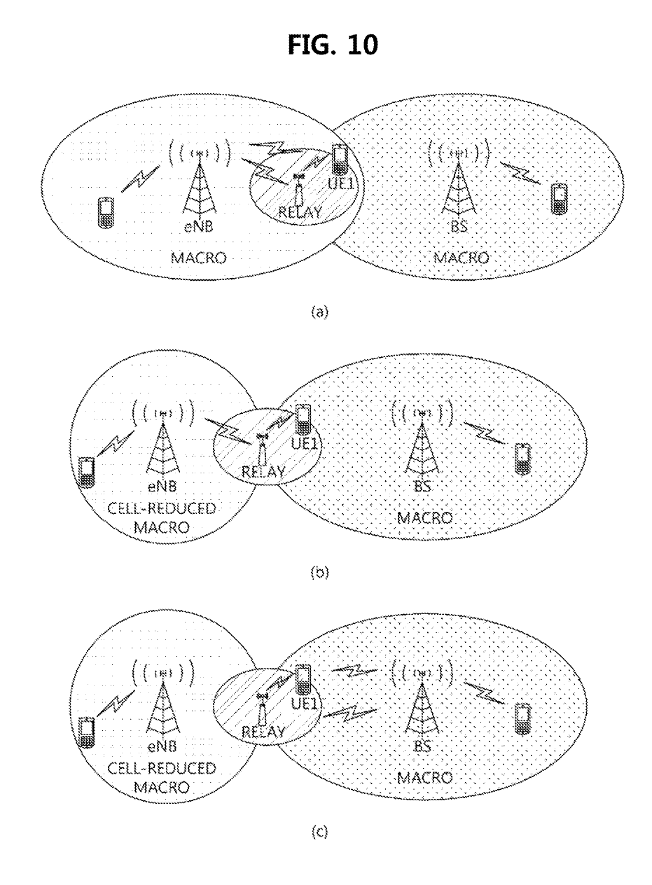

FIG. 10 illustrates examples of resource partitioning flexibly applied to a macro-relay cell of the range-extension concept according to a traffic situation.

(a), (b) and (c) of FIG. 10 illustrate examples of resource partitioning when a relay cell is between two types of macrocells controlled by an LTE-advanced eNB and a fourth generation (4G) base station. Specifically, FIG. 10 illustrates that UE1 may be served by the LTE-advanced eNB and the relay (a), by only the relay (b), or by the 4G base station and the relay (c) according to a traffic situation of UE1 present at the same position.

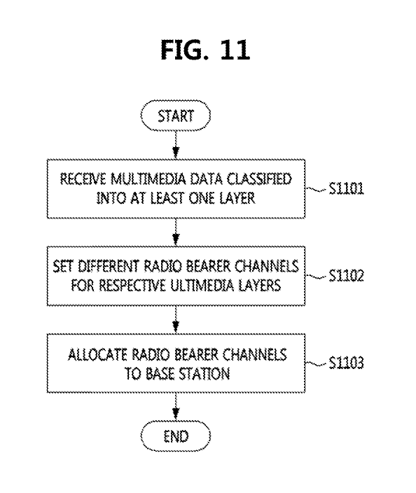

FIG. 11 is a flowchart illustrating a method of transmitting multimedia data in a wireless network according to an example embodiment of the present invention.

Referring to FIG. 11, a wireless network (e.g., a 3GPP LTE mobile communication network) according to an example embodiment of the present invention receives multimedia data classified into at least one layer from an interoperating wireless IP network (S1101). Here, the multimedia data may be classified into a base layer and an enhanced layer. The wireless network receiving the multimedia data sets different radio bearer channels for the respective multimedia layers (S1102). According to an example embodiment of the present invention, data related to the base layer may be transmitted using a coding scheme having a lower data rate and a modulation scheme having a lower level than data related to the enhanced layer.

The wireless network according to an example embodiment of the present invention allocates the at least one set radio bearer channel to at least one base station (S1103). At this time, the data related to the base layer may be a base station having larger cell coverage than the data related to the enhanced layer.

Although the above-described example embodiments of the present invention have mainly described media transmission in a mixed network of an IP network and an LTE mobile communication network as an example, the present invention is not limited to the example embodiments but can be applied universally. Also, the scope of the present invention includes all methods that can be applied universally. For convenience, the technology has been described in order of interoperation with a whole wired/wireless network including a video layer, but can interoperate with a part or the whole of the wired/wireless network.

Example embodiments of the present invention enable use of various QoSs, ARPs, etc., for example, when multimedia data is divided into a base layer and enhanced layers and transmitted in a media layer. Thus, transmission and reception are performed in an appropriate form to optimize overall QoS in the network layer, and end-to-end QoS is remarkably improved.

Also, example embodiments of the present invention provide a method that enables efficient use of relay and radio resources by optimizing HARQ and scheduling schemes in a wireless network, and thus can provide the maximum capacity and the best quality. Compared to an existing method, the method shows performance improved by about 20% or more.

While example embodiments of the present invention and their advantages have been described in detail, it should be understood that various changes, substitutions and alterations may be made herein without departing from the scope of the invention.

What is claimed is:

1. A method of transmitting multimedia data in a wireless network, comprising:
receiving multimedia data classified into at least one layer; and
setting different radio bearer channels for the respective at least one multimedia layer,
wherein a service quality parameter is differentially applied to the respective set radio bearer channels.

2. The method of claim 1, wherein the service quality parameter includes at least one of a quality of service (QoS) class identifier (QCI) and an allocation retention priority (ARP).

3. The method of claim 1, wherein the multimedia data is classified into a base layer and an enhanced layer.

4. The method of claim 3, wherein data related to the base layer is transmitted using a coding scheme having a lower data rate and a modulation scheme having a lower level than data related to the enhanced layer.

5. The method of claim 3, further comprising allocating at least one radio bearer channel to at least one base station.

6. The method of claim 5, wherein data related to the base layer is allocated to a base station having larger cell coverage than data related to the enhanced layer.

7. The method of claim 1, wherein the multimedia data classified into the at least one layer is encoded using at least one of scalable video coding (SVC), three-dimensional (3D) video coding, and multiview video coding (MVC).

8. The method of claim 1, wherein information on precedence of the at least one layer of the multimedia data is included in a header of a packet of the multimedia data.

9. The method of claim 1, wherein information on precedence of the at least one layer of the multimedia data is expressed by a traffic class bit in a service type field of an Internet protocol (IP) version 4 (IPv4) packet or a header of an IP version 6 (IPv6) packet.

10. The method of claim 3, wherein data related to the base layer is transmitted using a guaranteed bit rate (GBR), and data related to the enhanced layer is transmitted using a non-GBR.

11. An apparatus for transmitting multimedia data in a wireless network, wherein multimedia data classified into at least one layer is received, and different radio bearer channels are set for the respective at least one multimedia layer,
wherein a service quality parameter is differentially applied to the respective set radio bearer channels.

12. The apparatus of claim 11, wherein the service quality parameter includes at least one of a quality of service (QoS) class identifier (QCI) and an allocation retention priority (ARP).

13. The apparatus of claim 11, wherein the multimedia data is classified into a base layer and an enhanced layer.

14. The apparatus of claim 13, wherein data related to the base layer is transmitted using a coding scheme having a lower data rate and a modulation scheme having a lower level than data related to the enhanced layer.

15. The apparatus of claim 13, wherein the multimedia data classified into the at least one layer is encoded using at least one of scalable video coding (SVC), three-dimensional (3D) video coding, and multiview video coding (MVC).

16. The apparatus of claim 11, wherein information on precedence of the at least one layer of the multimedia data is included in a header of a packet of the multimedia data.

17. The apparatus of claim 13, wherein data related to the base layer is transmitted using a guaranteed bit rate (GBR), and data related to the enhanced layer is transmitted using a non-GBR.

18. The apparatus of claim 13, wherein information on precedence of the at least one layer of the multimedia data is expressed by a traffic class bit in a service type field of an Internet protocol (IP) version 4 (IPv4) packet or a header of an IP version 6 (IPv6) packet.
